(19) United States
(12) Patent Application Publication
(10) Pub. No.: US 2007/0095252 A1
(43) Pub. Date: May 3, 2007

(54) Composition for coating and film obtained therefrom

(76) Inventor: Fukashi Momose, Ginowan-si (JP)

Correspondence Address: JORDAN AND HAMBURG LLP, 122 EAST 42ND STREET, SUITE 4000, NEW YORK, NY, 10168, US

(21) Appl. No.: 11/266,719

(22) Filed: Nov. 3, 2005

(51) Int. Cl. C08J 5/12

(52) U.S. Cl. 106/287.3; 106/287.34; 106/436

(57) ABSTRACT

Provided are a composition for coating that can form a coating film having negative ion generating function, and a film obtained therefrom. Specifically, this composition can be obtained by so adjusting as to contain: (a) 1 to 35 parts by weight, in terms of SiO₂, of silica sol expressed by the general formula of M₂O.nSiO₂; (b) 0.1 to 30 parts by weight of ion generating material; (c) 0 to 50 parts by weight of inorganic filler; and (d) 5 to 80 parts by weight of water, provided (a)+(b)+(c)+(d)=100 parts by weight.

### BACKGROUND OF THE INVENTION

1. Field of the Invention

The present invention relates to a composition for coating (hereinafter referred to simply as a “composition”). More particularly, the invention relates to a composition capable of forming a film that is nonflammable and continuously generates the negative ion merely by applying it to the surface of metal such as aluminum, stainless steel and iron, or the surface of a base material such as ceramic, stone, cement concrete, slate plate, wood, paper and fabric, or the surface of an organic or inorganic coating film, and then heating at low temperatures for a short period of time, or drying at ordinary temperatures, so that it has, for example, deodorizing property, antibacterial property, and organic matter decomposing property, thereby contributing to the fields of fire prevention, environmental purification, and the like.

2. Description of the Background Art

As is well known, the negative ion is outstanding for its antibacterial property against Escherichia coli, yellow Staphylococcus, Pseudomonas aeruginosa, MRSA (Methicilin-Resistant Staphylococcus Aureus), and the like, and it also has deodorizing property and organic matter decomposing property.

As a source of the negative ion, cosmic rays, radon, plants, radioactive substance (ores containing a radioactive element) are known. In the recent years, titanium compounds (e.g., anatase type titanium dioxide, and titania phosphate) having the property of generating the negative ion under light (ultraviolet or non-visible light) irradiation were found, which are called photocatalyst.

Although the actions of photocatalyst and radioactive substance, being well known, will not be detailed, there is the following difference in ion generation between the two. That is, radioactive substance has the action of generating hydrogen peroxide (H₂O₂) and the negative ion (H⁺) when it makes contact with atmospheric water vapor mass and carbon dioxide. On the other hand, photocatalyst does not act unless it is subjected to light irradiation.

In a conventional technique of obtaining a coating film having the negative ion generating function, a composition has been adjusted in such a manner as to incorporate polymer binder in photocatalyst or radioactive substance, each of which is hereinafter referred to simply as “ion generating material.”

In practicing the composition according to the conventional technique, however, the following problems may be encountered. (1) Since this composition employs polymer binder (natural or synthetic liquid resin), when the binder is dried and cured, the surface of ion generating material dispersed in the composition will be covered with a water-proofing film to be formed by the resin. This makes it impossible for atmospheric water vapor mass and carbon dioxide to make a direct contact with the ion generating material, thus deteriorating the negative ion generating function of the film formed by the composition. (2) Since the polymer binder will be chemically decomposed by the organic bonding hand cutting action of the ion generating material, the deterioration of the binder that forms the film of this composition may be facilitated. This lowers the durability of the coating film formed by the composition.

### SUMMARY OF THE INVENTION

In view of the problems in the above conventional technique, the present invention has as its object to provide a composition having the following characteristics: (1) The composition is aqueous and free from volatile organic matter, and exhibits excellent operating performance; (2) By heating at ordinary temperatures or low temperatures (40 to 150° C.), the composition is dried and cured to form a coating film; (3) The coating film has siloxane bonding and the property of transmitting water vapor mass and carbon oxide; (4) The coating film is nonflammable and withstands temperatures as high as 1000° C. or above; (5) The coating film causes no deterioration by the negative ion and hydrogen peroxide, and exhibits excellent weather resistance; and (6) The coating film has the function of generating the negative ion, which enables it to effectively perform deodorization, antibacterial action, and volatile organic matter decomposing action. More particularly, the invention provides a composition that may be used for such various purposes as could not be handled satisfactorily in the past.

To achieve the above object, the invention is a composition for coating that is a mixture comprising: (a) as binder, 1 to 35 parts by weight, preferably 3 to 20 parts by weight, in terms of SiO₂, of at least one type of silica sol selected from the group of silica sols expressed by the general formula of M₂O.nSiO₂, where M is Na and (R₄N), n is a natural number, and R is a univalent organic group; (b) 0.1 to 30 parts by weight, preferably 0.3 to 10 parts by weight of at least one type of ion generating material selected from the group constituting of titanium compound having the property of generating the negative ion when ultraviolet or non-visible light is irradiated, and radioactive material having the property of generating the negative ion by radioactive ray (ore or ceramic containing a rare earth component); (c) 0 to 50 parts by weight, preferably 0 to 40 parts by weight of inorganic filler for purposes of the maintenance of film thickness, the coloring of film, and the like; and (d) 5 to 80 parts by weight, preferably 10 to 50 parts by weight of water, provided (a)+(b)+(c)+(d)=100 parts by weight.

Specifically, the present invention was achieved based on the following findings. A composition can be adjusted by incorporating and dispersing ion generating material in at least one type selected from the group of silica sols, further by adding and blending inorganic filler as required. This results in that inorganic binder composed of silica sol forms a film through which water vapor mass and carbon dioxide essential for the negative ion generation can pass; that the inorganic binder composed of silica sol forms such a film as may not be deteriorated by the negative ion, because it is unaffected by the organic bonding hand cutting action of the negative ion; and that the film so formed combines the characteristics of high negative ion generating function, nonflammability and durability.

A composition for coating according to the invention can form a coating film that is nonflammable and has the function of continuously generating the negative ion merely by applying it to the surface of metal such as aluminum, stainless steel and iron, or the surface of a base material such as cement concrete, slate plate, stone, wood, paper, fabric, plastic and ceramic, or the surface of an organic or inorganic coating film, and then heating at low temperatures for a short period of time, or drying at ordinary temperatures. This coating film can flexibly be colored. Additionally, the coating film formed by the above composition continuously generates the negative ion, which enables it to perform antibacterial action and organic material decomposition.

### DESCRIPTION OF THE PREFERRED EMBODIMENTS

The present invention will be described in detail for each component.

Component (a), namely silica sol, used in the invention may be any of silica sols that can be expressed by the general formula of M₂O.nSiO₂ (M is Na and (R₄N), n is a natural number, and R is a univalent organic group), on which no special limit is imposed. These may be used alone or along with curing agent, and heated at low temperatures (40 to 150° C.) or dried and cured at ordinary temperatures, thereby exhibiting film forming property. Specifically, the component (a) can be adjusted by suspending silicic acid (SiO₂) in a dispersion medium such as sodium solution or quaternary ammonium salt solution.

Component (b), namely ion generating material, used in the invention is material having ion generating function, more particularly, nonaqueous material having the property of generating hydrogen peroxide and hydrogen when atmospheric water vapor mass and carbon dioxide are brought into contact with each other concurrently. Specifically, the composition (b) is such material that the above property can be excited by light (hereinafter referred to simply as photocatalyst), and material having radioactivity (hereinafter referred to simply as radioactive material), each of which is well known as material that generates the negative ion. More specifically, examples of the former are anatase type titanium dioxide having such property that the above action can be excited by ultraviolet, and titania phosphate compound having such property that the above action can be excited by non-visible light. The latter is ore or ceramic having radioactivity. It is desirable for safety in practice that the radioactive material used in the invention is material whose radioactivity is not more than 370 becquerel/g (radioactive concentration), thus requiring no permission to use. Further, the component (b) is at least one selected from the group consisting of photocatalyst and radioactive material, and its average particle diameter or average length is preferably not more than 100 μm, more preferably 0.1 to 50 μm.

Component (c), namely inorganic filler, used in the invention may be employed depending on the purposes such as the coloring of coating film, the adjustment of coating film thickness, the adjustment of coating film hardness. Its average particle diameter or average length is preferably 0.1 to 100 μm, more preferably 0.5 to 30 μm. As such inorganic filler, nonaqueous one in the shape of particle or fabric is desirable. For example, there are inorganic body pigment, inorganic pigment, functional pigment, and metal powder. One or more than one type selected from this group can be used. Examples of inorganic body pigment and functional pigment are silica, zircon, alumina, kaolin, talc, zeolite, calcium carbonate, silicon carbide, various whiskers, potsherd, bentonite, tolumarine, ferrite, and carbon. Examples of inorganic pigment are oxides of titanium, chrome, iron, zinc, cobalt, manganese, and nickel, as well as composite compounds of these. Examples of metal powder are iron powder, stainless steel powder, nickel powder, brass powder, copper powder, and zinc powder. These are cited merely by way of example and without limitation.

Component (d), namely water, used in the invention is essential for adjusting the viscosity of a composition, or the dispersion of ion generating material and inorganic filler. Ion-exchange water, distilled water, and tap water can be used. Also, water contained in silica sol of the above (a) can be included.

Besides the above components (a) to (d), the composition of the invention can contain an additive component (e), such as various dispersing agents, surface active agents, plasticizers, and curing agents, as required. The amount of addition of the component (e) is arbitrary, which can be calculated by exterior division with respect to the sum of the components of the composition.

The composition of the invention can be adjusted by incorporating and dispersing the components (b), (c), (d), and (e) in the component (a). Specifically, the composition can be obtained by putting the above components (a) to (d), and the additive (e) as required, in a high-speed agitator, ball mill, or other disperser, and then agitating these components.

The composition of the invention can be obtained in the state of semitransparent or colored liquid, so that it can be used by applying to concrete, stone, metal, wood, paper, fabric, and the like. The composition has such property that it can be dried and cured to form a film by heating at ordinary temperatures or at low temperature for a short period of time (50 to 150° C.).

Alternatively, the composition of the invention can be coated on a base material by using coating means such as brush, spray, flow coat, roll coat, and dipping.

The coating film obtained from the composition of the invention is inflammable and has the negative ion generating function, so that it has wide applications such as deodorization, antibacterial activity, and organic matter decomposition, thus taking effects.

### EXAMPLES

The present invention will be discussed more specifically with reference to examples. However, it is to be understood that it is not limited to the following examples, provided they do not exceed the scope of the invention. In the examples, “parts” and “%” indicate weight, unless otherwise noted. Also in the examples, “parts” and “%” in the additive component (e) indicate the weight to be obtained by exterior division with respect to the sum of the composition components.

### Experiment 1

Adjusted were 45 compositions shown in Tables 1-1, 1-2, 1-3, 1-4, 1-5, 1-6, and 1-7. In adjusting the compositions, each of the components as shown in the tables was put in a pot mill and agitated for 60 minutes at 120 r.p.m (revolutions per minute). This was then taken out and filtered with a sieve (100-mesh).

The following symbols used in these tables indicate as follows:

(a) component: silica sol

(a) N30: silica sol #30 (silica sol with sodium solution as dispersion medium, which is about 30% in SiO₂ concentration and manufactured by Nippon Chemical Ind.)

(a) N50: silica sol #50 (silica sol with sodium solution as dispersion medium, which is about 50% in SiO₂ concentration and manufactured by Nippon Chemical Ind.)

(a) AS: ammonium silicate AS (silica sol with quaternary ammonium salt solution as dispersion medium, which is about 40% in SiO₂ concentration and manufactured by Nippon Chemical Ind.)

(b) component: ion generating material

(b) T: anatase type titanium dioxide (ultraviolet excitation material that is 0.5 μm in average particle diameter and manufactured by SAKAI CHEMICAL INDUSTRY CO., LTD.)

(b) PT: titania phosphate compound (non-visible light excitation material that is 0.5 μm in average particle diameter)

(b) M: monazite ore (natural radioactive material that is 1 82 m in average particle diameter, 5 to 7 μ Sv/5 mm of measuring distance in radiation dose equivalent, and manufactured by Serayamaichi)

(b) SE: ceramic (that is 1 μm in average particle diameter, and composed of 38% moinazite, 28% anatase type titanium dioxide, and 34% China clay)

(c) component: inorganic filler

(c) 1: aluminum whisker (1 μm in average particle diameter)

(c) 2: calcium carbonate (1 μm in average particle diameter)

(c) 3: chromium oxide (green pigment) (0.5 μm in average particle diameter)

(d) component: water

(d) 1: ion-exchange water

(e) other component: additive

(e) 1: dispersing agent/nonionic surface active agent

TABLE 1-1

| Type of | Type of Composition | | | | | | |
|---|---|---|---|---|---|---|---|
| Components (part) | N30-1 | N30-2 | N30-3 | N30-4 | N30-5 | N30-6 | N30-7 |
| (a) N30 | 50. | 50. | 50. | 50. | 80. | 80. | 80. |
| (a) N50 | | | | | | | |
| (a) AM | | | | | | | |
| (b) T | 3. | | | | 5. | | |
| (b) PT | | 3. | | | | 5. | |
| (b) M | | | 3. | | | | 5. |
| (b) SE | | | | 3. | | | |
| (c) 1 | | | | | 3. | 3. | 3. |
| (c) 2 | | | | | 5. | 5. | 5. |
| (c) 3 | | | | | 7. | 7. | 7. |
| (d) 1 | 47. | 47. | 47. | 47. | | | |
| Total parts | 100. | 100. | 100. | 100. | 100. | 100. | 100. |
| (e) 1 | | | | | | | |

TABLE 1-2

| Type of | Type of Composition | | | | | | |
|---|---|---|---|---|---|---|---|
| Components (part) | N50-1 | N50-2 | N50-3 | N50-4 | N50-5 | N50-6 | N50-7 |
| (a) N30 | | | | | | | |
| (a) N50 | 50. | 50. | 50. | 50. | 80. | 80. | 80. |
| (a) AM | | | | | | | |
| (b) T | 3. | | | | 5. | | |
| (b) PT | | 3. | | | | 5. | |
| (b) M | | | 3. | | | | 5. |
| (b) SE | | | | 3. | | | |
| (c) 1 | | | | | 3. | 3. | 3. |
| (c) 2 | | | | | 5. | 5. | 5. |
| (c) 3 | | | | | 7. | 7. | 7. |
| (d) 1 | 47. | 47. | 47. | 47. | | | |
| Total parts | 100. | 100. | 100. | 100. | 100. | 100. | 100. |
| (e) 1 | | | | | | | |

TABLE 1-3

| Type of | Type of Composition | | | | | | |
|---|---|---|---|---|---|---|---|
| Components (part) | AM-1 | AM-2 | AM-3 | AM-4 | AM-5 | AM-6 | AM-7 |
| (a) N30 | | | | | | | |
| (a) N50 | | | | | | | |
| (a) AM | 50. | 50. | 50. | 50. | 80. | 80. | 80. |
| (b) T | 3. | | | | 5. | | |
| (b) PT | | 3. | | | | 5. | |
| (b) M | | | 3. | | | | 5. |
| (b) SE | | | | 3. | | | |
| (c) 1 | | | | | 3. | 3. | 3. |
| (c) 2 | | | | | 5. | 5. | 5. |
| (c) 3 | | | | | 7. | 7. | 7. |
| (d) 1 | 47. | 47. | 47. | 47. | | | |
| Total parts | 100. | 100. | 100. | 100. | 100. | 100. | 100. |
| (e) 1 | | | | | | | |

TABLE 1-4

| Type of | | | | | | |
|---|---|---|---|---|---|---|
| Components | Type of Composition | | | | | |
| (part) | N30-A | N30-B | N50-A | N50-B | AM-A | AM-B |
| (a) N30 | 50. | 81.7 | | | | |
| (a) N50 | | | 50. | 81.7 | | |
| (a) AM | | | | | 50. | 81.7 |
| (b) T | 1. | 1. | 1. | 1. | 1. | 1. |
| (b) PT | 1. | 1. | 1. | 1. | 1. | 1. |
| (b) M | 1. | | 1. | | 1. | |
| (b) SE | | 1. | | 1. | | 1. |
| (c) 1 | | 5. | | 5. | | 5. |
| (c) 2 | | 5. | | 5. | | 5. |
| (c) 3 | | 5. | | 5. | | 5. |
| (d) 1 | 47. | | 47. | | 47. | |
| Total parts | 100. | 100. | 100. | 100. | 100. | 100. |
| (e) 1 | | 0.3 | | 0.3 | | 0.3 |

TABLE 1-5

| Type of | | | | | | |
|---|---|---|---|---|---|---|
| Components | Type of Composition | | | | | |
| (part) | N30-F | N30-G | N30-H | N30-I | N30-J | N30-K |
| (a) N30 | 84.9 | 84.9 | 84.9 | 84.9 | 84.9 | 84.9 |
| (a) N50 | | | | | | |
| (a) AM | | | | | | |
| (b) T | 0.1. | | | | 0.1 | 0.1 |
| (b) PT | | 0.1 | | | 0.1 | 0.1 |
| (b) M | | | 0.1 | | 0.1 | |
| (b) SE | | 0.1 | | 0.1 | | 0.1 |
| (c) 1 | 5.0 | 5.0 | 5.0 | 5.0 | 5.0 | 5.0 |
| (c) 2 | 5.0 | 5.0 | 5.0 | 5.0 | 5.0 | 5.0 |
| (c) 3 | 5.0 | 5.0 | 5.0 | 5.0 | 5.0 | 5.0 |
| (d) 1 | | | | | | |
| Total part | 100. | 100. | 100. | 100. | 100. | 100. |

TABLE 1-6

| Type of | | | | | | |
|---|---|---|---|---|---|---|
| Components | Type of Composition | | | | | |
| (part) | N50-F | N50-G | N50-H | N50-I | N50-J | N50-K |
| (a) N30 | | | | | | |
| (a) N50 | | | | | | |
| (a) AM | | | | | | |
| (b) T | 0.1. | | | | 0.1 | 0.1 |
| (b) PT | | 0.1 | | | 0.1 | 0.1 |
| (b) M | | | 0.1 | | 0.1 | |
| (b) SE | | 0.1 | | 0.1 | | 0.1 |
| (c) 1 | 5.0 | 5.0 | 5.0 | 5.0 | 5.0 | 5.0 |
| (c) 2 | 5.0 | 5.0 | 5.0 | 5.0 | 5.0 | 5.0 |
| (c) 3 | 5.0 | 5.0 | 5.0 | 5.0 | 5.0 | 5.0 |
| (d) 1 | | | | | | |
| Total parts | 100. | 100. | 100. | 100. | 100. | 100. |

TABLE 1-7

| Type of | | | | | | |
|---|---|---|---|---|---|---|
| Components | Type of Composition | | | | | |
| (part) | AM-F | AM-G | AM-H | AM-I | AM-J | AM-K |
| (a) N30 | | | | | | |
| (a) N50 | | | | | | |
| (a) AM | | | | | | |
| (b) T | 0.1. | | | | 0.1 | 0.1 |
| (b) PT | | 0.1 | | | 0.1 | 0.1 |
| (b) M | | | 0.1 | | 0.1 | |
| (b) SE | | 0.1 | | 0.1 | | 0.1 |
| (c) 1 | 5.0 | 5.0 | 5.0 | 5.0 | 5.0 | 5.0 |
| (c) 2 | 5.0 | 5.0 | 5.0 | 5.0 | 5.0 | 5.0 |
| (c) 3 | 5.0 | 5.0 | 5.0 | 5.0 | 5.0 | 5.0 |
| (d) 1 | | | | | | |
| Total parts | 100. | 100. | 100. | 100. | 100. | 100. |

### Experiment 2

Measurement of Amount of Negative Ion Generation

Each of the 45 compositions shown in Tables 1-1 to 1-7 was applied to one surface of a slate plate (dimension: 150 mm×150 mm×5 mm), and dried for 24 hours at an ordinary temperature (25° C.). With use of a negative ion counter (ITC-202 type, manufactured by Alps Electric Co., Ltd.), the amount of the negative ion generated from the formed coating film (i.e., the number per 1 cc) was measured. The amount of application of the composition, and the measured value of the negative ion are shown in Tables 2-1 and 2-2. In these tables, “blank” indicates the measured value of a slate plate to which no composition was applied, and it can be regarded as the amount of the indoor negative ion.

TABLE 2-1
(Measuring Conditions: Room temp: 27° C.; Relative humidity:
57%; Illumination: 60 lux/fluorescent lamp)

| | Amount of application of | Measured value of |
|---|---|---|
| Type of | Composition | negative ion |
| Composition | (g/piece) | (piece/cc) |
| Blank | — | 50.≧ |
| N30-1 | 15.3 | 680. |
| N30-2 | 15.1 | 790. |
| N30-3 | 15.3 | 4650. |
| N30-4 | 15.4 | 3280. |
| N30-5 | 15.2 | 760. |
| N30-6 | 15.3 | 890. |
| N30-7 | 15.2 | 6980. |
| N50-1 | 15.1 | 650 |
| N50-2 | 15.3 | 810. |
| N50-3 | 15.4 | 4890. |
| N50-4 | 15.2 | 3110. |
| N50-5 | 15.3 | 780. |
| N50-6 | 15.2 | 910. |
| N50-7 | 15.4 | 6960. |
| AM-1 | 15.3 | 710. |
| AM-2 | 15.2 | 750. |
| AM-3 | 15.2 | 4670. |
| AM-4 | 15.4 | 2980. |
| AM-5 | 15.3 | 690. |
| AM-6 | 15.1 | 820. |
| AM-7 | 15.4 | 6540. |

TABLE 2-2
(Measuring Conditions: Room temp: 27° C.; Relative humidity:
57%; Illumination: 60 lux/fluorescent lamp)

| | Amount of application of | Measured value of |
|---|---|---|
| Type of | Composition | negative ion |
| Composition | (g/piece) | (piece/cc) |
| Blank | — | 50.≦ |
| N30-A | 15.3 | 2170. |
| N30-B | 15.4 | 1840. |
| N50-A | 15.1 | 2110. |
| N50-B | 15.1 | 1750. |
| AM-A | 15.4 | 2310. |
| AM-B | 15.2 | 1880. |
| N30-F | 15.3 | 540. |
| N30-G | 15.2 | 780. |
| N30-H | 15.1 | 1230. |
| N30-I | 15.3 | 1180. |
| N30-J | 15.1 | 1420. |
| N30-K | 15.4 | 1240. |
| N50-F | 15.2 | 440. |
| N50-G | 15.2 | 680. |
| N50-H | 15.3 | 1810. |
| N50-I | 15.1 | 1110. |
| N50-J | 15.4 | 1230. |
| N50-K | 15.5 | 1140. |
| AM-F | 15.2 | 310. |
| AM-G | 15.3 | 660. |
| AM-H | 15.2 | 1260. |
| AM-I | 15.3 | 1090. |
| AM-J | 15.4 | 1400. |
| AM-K | 15.1 | 1190. |

Experiment 2 has disclosed that the coating films formed by the compositions of the invention have the function of generating the negative ion.

### Experiment 3

To examine the influence of the film formed by polymer binder on the amount of the negative ion generation, the compositions shown in Table 3 were adjusted, and the amount of the negative ion generated from the formed film was measured in the same manner as in Experiment 2. The amounts of application of the compositions and the measured values were shown in Table 4. In these tables, “(f) A” indicates polymer binder, particularly, hydrosol of acrylic resin (Arumatex E-170, having a solid content of 45%, manufactured by Mitsui Chemical Inc.).

TABLE 3
Table of Compositions

| Type of | Type of Composition | | | | | |
|---|---|---|---|---|---|---|
| Component (part) | AC-1 | AC-2 | AC-3 | AC-4 | AC-5 | AC-6 |
| (f) A | 84.9 | 84.9 | 84.9 | 84.9 | 84.9 | 84.9 |
| (b) T | 0.1 | | | | 0.1 | 0.1 |
| (b) PT | | 0.1 | | | 0.1 | 0.1 |
| (b) M | | | 0.1 | | 0.1 | |
| (b) SE | | | | 0.1 | | 0.1 |
| (c) 1 | 5.0 | 5.0 | 5.0 | 5.0 | 5.0 | 5.0 |
| (c) 2 | 5.0 | 5.0 | 5.0 | 5.0 | 5.0 | 5.0 |
| (c) 3 | 5.0 | 5.0 | 5.0 | 5.0 | 5.0 | 5.0 |
| (d) 1 | | | | | | |
| Total parts | 100. | 100. | 100. | 100. | 100. | 100. |

TABLE 4
Measured Values
(Measuring Conditions: Room temp: 27° C.; Relative humidity:
57%; Illumination: 60 lux/fluorescent lamp)

| | Amount of application of | Measured value of |
|---|---|---|
| Type of | Composition | negative ion |
| Composition | (g/piece) | (piece/cc) |
| Blank (within laboratory) | — | 50.≦ |
| AC-1 | 15.3 | 90. |
| AC-2 | 15.4 | 150. |
| AC-3 | 15.2 | 810. |
| AC-4 | 15.2 | 740. |
| AC-5 | 15.2 | 860. |
| AC-6 | 15.2 | 850. |

Experiment 3 has disclosed that the polymer binder interferes with the effect of the ion generating material incorporated in the composition, and also reduces the amount of the negative ion generation.

### Experiment 4

To examine how effectively the negative ion generated from the coating film formed by the composition of the invention can perform the action of decomposing organic matter, red ink (organic dye) was added dropwise to each of the coating films of the compositions adjusted in Experiment 2. The state in which the red ink was decomposed and faded away was observed with the naked eye, in order to determine the number of days necessary for the color of the ink to fade out. The results are shown in Table 5. This red ink was prepared by diluting a cartridge spare ink (product number IRF-12S-R), manufactured by PILOT Corporation, with 15 times distilled water. With use of a syringe, 0.2 cc was added dropwise onto each of the coating films of the compositions.

TABLE 5
(Measuring Conditions: Under irradiation of indoor fluorescent lamp)

| | Amount of application of | Number of days |
|---|---|---|
| Type of | Composition | necessary for red color |
| Composition | (g/piece) | to fade out |
| Blank (slate plate) | — | Red color remained after |
| | | 240 days |
| N50-1 | 22. | Within 60 days |
| N50-2 | 23. | Within 60 days |
| N50-3 | 21. | Within 40 days |
| N50-4 | 22. | Within 40 days |
| N50-5 | 22. | Within 60 days |
| N50-6 | 21. | Within 60 days |
| N50-7 | 20. | Within 30 days |

Experiment 4 has disclosed that the coating films formed by the compositions of the invention generate the negative ion, and have the effect of causing the coloring function of organic dye to fade out, thus exhibiting the action of decomposing organic matter.

### Experiment 5

To examine the effect of deodorizing action of the negative ion generated from each of the coating films formed by the compositions of the invention, 3-L ammonia gas adjusted to a predetermined concentration was admitted in two Tedlar-bags. A piece of drawing paper (size: 300 mm×300 mm×5 mm), to both sides of which 35 g of the composition adjusted in Experiment 3 was applied previously, was put in one of the two Tedlar-bags. The other Tedlar-bag was empty (blank). The concentrations of ammonia in the two Tedlar-bags were measured per elapsed time by a detector tube, and the measured values were compared. The types of compositions and the results of measurements are shown in Table 6.

TABLE 6
(Measuring Conditions: Room temp: 25° C.;
Under irradiation of 500-lux fluorescent lamp)

| Type of | Concentration of ammonia (ppm) | | |
|---|---|---|---|
| Composition | Initial concentration | After 2 hours | After 24 hours |
| Blank | 40. | 34. | 23. |
| N50-1 | 40. | 25. | Not more than 0.5 |
| N50-2 | 40. | 20. | Not more than 0.5 |
| N50-3 | 40. | 1.5 | Not more than 0.5 |
| N50-4 | 40. | 1.8 | Not more than 0.5 |
| N50-5 | 40. | 19. | Not more than 0.5 |
| N50-6 | 40. | 15. | Not more than 0.5 |
| N50-7 | 40. | 1.1 | Not more than 0.5 |
| AM-1 | 40. | 27. | Not more than 0.5 |
| AM-2 | 40. | 27. | Not more than 0.5 |
| AM-3 | 40. | 1.6 | Not more than 0.5 |
| AM-4 | 40. | 2.1 | Not more than 0.5 |
| AM-5 | 40. | 24. | Not more than 0.5 |
| AM-6 | 40. | 20. | Not more than 0.5 |
| AM-7 | 40. | 1.2 | Not more than 0.5 |

Experiment 5 has disclosed that the coating films formed by the compositions of the invention exhibit deodorizing action.

### Experiment 6

To examine the effect of the antibacterial action of the negative ion generated from each of the coating films formed by the compositions of the invention, evaluation was made in the following manner. That is, Escherichia coil, Pseudomonas aeruginosa, yellow Staphylococcus, and Methicilin-Resistant Staphylococcus Aureus (MRSA) were respectively added dropwise to individual stainless steel plates (size: 70 mm×70 mm×1.8 mm), on which the composition (AM-7) of the invention was previously coated. After allowing these to stand for one hour, liquid bacteria was recovered by an applicator. Then, the number of bacteria at the time of dropping and that at the time of recovery were compared by microscopy, thus calculating the rate of decrease of bacteria.

Method of Calculating Rate of Decrease of Bacteria:
Rate of Decrease of Bacteria (%)={(Number of bacteria in recovered liquid bacteria)÷(Number of bacteria in liquid bacteria at the time of dropping)}×100

The results of the experiment was shown in Table 7, in which blank indicates the rate of decrease of bacteria in case of using a stainless steel plate without coating.

TABLE 7
(Measuring Conditions: Room temp: 25° C.;
Under irradiation of 1000-lux fluorescent lamp)

| | Type of | | | |
|---|---|---|---|---|
| | bacteria | | | |
| | Rate of decrease of bacteria after one hour (%) | | | |
| Type of | Escherichia | Pseudomonas | Yellow | |
| Composition | coil | aeruginosa | Saphylococcus | MRSA |
| Blank | 0. | 0. | 0. | 0. |
| N50-1 | 99.9 | 99.9 | 99.9 | 99.9 |
| N50-2 | 99.9 | 99.9 | 99.9 | 99.9 |
| N50-3 | 99.9 | 99.9 | 99.9 | 99.9 |
| N50-4 | 99.9 | 99.9 | 99.9 | 99.9 |
| N50-5 | 99.9 | 99.9 | 99.9 | 99.9 |
| N50-6 | 99.9 | 99.9 | 99.9 | 99.9 |
| N50-7 | 99.9 | 99.9 | 99.9 | 99.9 |

Experiment 6 has disclosed that the coating films formed by the compositions of the invention exhibit antibacterial property against Escherichia coil, Pseudomonas aeruginosa, yellow Staphylococcus, and MRSA.

### Experiment 7

Each of the compositions of the invention was applied to a stainless steel plate (size: 70 mm×150 mm×1.2 mm), and dried by allowing it to stand indoors for 24 hours. The obtained coating film was exposed to the flame of a gas burner (at temperatures of about 800° C.) for 60 seconds, in order to examine the presence or absence of fuming, the presence or absence of the coating film peeling, and the change of appearance (the presence or absence of burning trace). The results were shown in Table 8.

TABLE 8

| Type of | | Coating | |
|---|---|---|---|
| Composition | Fuming | film peeling | Burning trace |
| N30-1 | Nil | Nil | nil |
| N30-2 | Nil | Nil | nil |
| N30-3 | Nil | Nil | nil |
| N30-4 | Nil | Nil | nil |
| N30-5 | Nil | Nil | nil |
| N30-6 | Nil | Nil | nil |
| N30-7 | Nil | Nil | nil |
| N50-1 | Nil | Nil | nil |
| N50-2 | Nil | Nil | nil |
| N50-3 | Nil | Nil | nil |
| N50-4 | Nil | Nil | nil |
| N50-5 | Nil | Nil | nil |
| N50-6 | Nil | Nil | nil |
| N50-7 | Nil | Nil | nil |
| AM-1 | Nil | Nil | nil |
| AM-2 | Nil | Nil | nil |
| AM-3 | Nil | Nil | nil |
| AM-4 | Nil | Nil | nil |
| AM-5 | Nil | Nil | nil |
| AM-6 | Nil | Nil | nil |
| AM-7 | Nil | Nil | nil |

Experiment 7 has disclosed that the formed films of the compositions of the invention are inflammable.

The compositions of the invention may be coated on, for example, indoor concrete, stone, and wood, so as to serve purposes such as odor elimination, nicotine decomposition, decomposition of volatile organic matter that can cause sick house syndrome, and antibacterial activity against Escherichia coil, Pseudomonas aeruginosa, yellow Staphylococcus, and Methicilin-Resistant Staphylococcus Aureus (MRSA), as well as the maintenance of sanitation. Alternatively, the compositions may be coated on metal so as to form an inflammable decorative film, allowing it to perform the above actions. Hence, the compositions of the invention can be used in such a wide range of applications as could not be handled satisfactorily in the past.

What is claimed is:

1. A composition for coating that contains: (a) 1 to 35 parts by weight, in terms of SiO₂, of silica sol expressed by the general formula of M₂O.nSiO₂, where M is Na and R₄N (R is a univalent organic acid); (b) 0.1 to 30 parts by weight of ion generating material; (c) 0 to 50 parts by weight of inorganic filler; and (d) 5 to 80 parts by weight of water, provided (a)+(b)+(c)+(d)=100 parts by weight.

2. The composition for coating according to claim 1 wherein,
the ion generating material (b) is nonaqueous material having an average particle diameter or average length of not more than 100 μm, and is at least one selected from the group consisting of (i) titanium compound having such property that its negative ion generating action can be excited by ultraviolet or non-visible light; (ii) ores containing a radioactive element; and (iii) ceramic containing the two materials (i) and (ii).

3. The composition for coating according to claim 1 wherein,
the inorganic filler (c) is nonaqueous material having an average particle dimension or average length of 0.1 to 100 μm, and is at least one selected from the group consisting of inorganic body pigment, inorganic functional pigment, and metal.

4. A film having negative ion generating function that can be obtained from a composition for coating according to one of claims 1 to 3.
